(19) United States
(12) Patent Application Publication
(10) Pub. No.: US 2014/0334058 A1
(43) Pub. Date: Nov. 13, 2014

(54) Automated and remotely operated stun gun with integrated camera and laser sight

(71) Applicants: David W. Galvan, Park Hills, MO (US); Dennis W. Horton, Park Hills, MO (US); Luke Rogers, Cadet, MO (US)

(72) Inventors: David W. Galvan, Park Hills, MO (US); Dennis W. Horton, Park Hills, MO (US); Luke Rogers, Cadet, MO (US)

(21) Appl. No.: 14/120,228

(22) Filed: May 9, 2014

Related U.S. Application Data
(60) Provisional application No. 61/855,309, filed on May 13, 2013.

(51) Int. Cl. F41H 13/00; H04N 7/18

(52) U.S. Cl. CPC F41H 13/0025; H04N 7/18
USPC 361/232

(57) ABSTRACT

An automated and remotely operated stun gun with integrated camera and laser sight, all incorporated within a housing, communicating either by hardwire or wireless to a control center, the camera, sight, and stun gun darts all embodied within a housing, capable of being moved for sighting purposes onto a suspect target, through the use of servo motors or other mechanical devices, so that once a target is sighted, the stun gun can be initiated, for disabling the suspect.

### CROSS REFERENCE TO RELATED APPLICATION

This non-provisional patent application claims priority to provisional patent application having Ser. No. 61/855,309, filed on May 13, 2013.

### FIELD OF THE INVENTION

This invention relates to an improved design for a stun gun, which is integrated with a security camera and laser sighting means, all of which can be remotely operated, so as to be located at a strategic location and ready for aiming at a suspect, sighting, and propelling the stun gun darts, to provide safety to the surrounding individuals that are being threatened by the person intending to do harm.

### BACKGROUND OF THE INVENTION

This invention generally relates to the application of a stun gun, and its technology, which is integrated with a camera, for sighting purposes, and a laser, for perfecting the sighting of the gun in preparation for its firing at an individual intending to do harm to the surrounding intended victims and the facilities.

Stun guns have been around for many years. They generally operate off of very high voltage, transmitted through charge transmitting wires, connected to the guns darts, which when embedded in the target, can provide a high charge that temporarily incapacitates a person without doing any long term damage or harm. This allows for the authorities and others to apprehend the person intending to perform personal attacks.

Obviously, surveillance cameras have been in use for many years. While more current usage by the authorities or for just that purpose, to see what is occurring at particular location, and even more recently have been controversially installed for application to combat against speeding, as on our roadways.

Laser sights have likewise been available for some time. Primarily they are used for military purposes, but such sights have also found there way into the field of hunting, to aid the hunter in aiming his rifle at the quarry, or lasers likewise have been used for industrial purposes, such as for setting up instrumentation, machinery, and the parts to be worked upon, to provide for a very precise positioning of any component to be machined, assembled, or the like.

These are all examples of the availability of the various components that have been integrated into the structure of the current invention, which have been devised to provide for automated application, whether it be by hardwiring, or remote transmission, of controls to manipulate a containerized stun gun, that incorporates a camera for viewing, a laser for sighting, and for initiating the propelling of the guns darts or projectiles, in order to disable a person intending to do harm to others. At the minimum, the current invention may provide a deterrent against those who want to do harm in crowded places, whether it be at the shopping mall, at other locations where crowds gather, in schools, and at other venues.

Examples of prior art styles of stun guns can be seen in various previous patents. For example, the patent assigned to TASER International, Inc., U.S. Pat. No. 7,075,770, shows a Less Lethal Weapons and Methods for Halting Locomotion. This patent shows a standard handheld stun gun, for use for incapacitating a human target. Generally, they operate off of the generation of lower amperage, at very high voltage, normally providing a series of output pulses, which when the electrodes or darts contact the clothing, or the body of the individual, causes a contraction of his/her muscles rendering them inoperative, and substantially reducing the locomotion of the intended target.

U.S. Pat. No. 7,234,262, shows another Electrical Weapon Having Controller for Timed Current through Target and Date/Time Recording. Usually these types of stun guns are for application by the police officer or other law enforcement agent and that can prevent an attacker or other violent individual from reaching and inflicting bodily harm upon the police officer.

Combined flashlight and stun gun can be seen in Patent No. D674,943, in addition to Patent No. D671,249. Patent No. D661,771, which show the appearance of a stun gun, while Patent No. D646,346, shows the combination of a flashlight stun gun. Once again, all of these devices are for handhold usage, and primarily applied for self-defense, whether it is by the policeman, or any individual carrying the same for protection.

U.S. Pat. No. 6,636,412 shows another handheld stun gun for incapacitating a human target. U.S. Pat. No. 6,256,916, shows another handheld style of stun gun. U.S. Pat. No. 6,022,120, shows a lighting device for a handheld stun gun. Stun guns for use for more long range applications can be seen in the pistol like gun, which also incorporates a laser, as noted in U.S. Pat. No. 5,473,501. But this is also a handheld style of stun gun.

U.S. Pat. No. 6,807,762 shows another variation upon a Stun Gun, that incorporates a form of a handle for its holding during usage.

Laser sights, principally for use in conjunction with a rifle or pistol, can be seen in U.S. Pat. No. 8,132,353. A firearm incorporating an embedded laser sight can be seen in U.S. Pat. No. 7,421,818. A laser sight assembly, for use with a revolver, and which can be incorporated therein, is shown in U.S. Pat. No. 5,784,823. Patent No. 5,694,713, shows a handgun with internal laser sight having elevational adjustment mechanism. The combination of a laser sight, adapted for usage with a camera, is shown in U.S. Pat. No. 5,437,104, defined as a laser sight mounting device for mounting a laser sight on the flash attachment of a camera. U.S. Pat. No. 5,419,072, shows another internal laser sight for a weapon. U.S. Pat. No. 8,327,573 shows a rifle scope with its integrated laser sight. U.S. Pat. No. 5,323,555 discloses an adjustable type laser sight.

The prior art also shows various styles of surveillance cameras, such as can be seen in U.S. Pat. No. 8,035,691, entitled a method and apparatus for compensating for movement of a video surveillance camera. U.S. Pat. No. 7,362,372, shows another network for operating a video surveillance camera. U.S. Pat. No. 6,992,723, discloses an integrated enclosure for a video surveillance camera.

U.S. Pat. No. 7,659,922 shows an internet video surveillance camera system and method.

Devices and methods for focusing a camera onto particular targets can be seen in U.S. Pat. No. 8,253,797, identified as a camera image georeferencing system.

U.S. Pat. No. 8,050,206 discloses what is identified as a wireless type of network camera system. U.S. Pat. No. 7,978,061 discloses a surveillance system and method.

U.S. Pat. No. 7,888,609 discloses what is defined as a mounting assembly for a surveillance means.

U.S. Pat. No. 7,636,104 discloses a video surveillance system.

U.S. Pat. No. 7,619,366 shows a system for and method of controlling a light source and lighting arrangement. In other words, this device provides for controlling the arrangement and focusing of lighting at an installation. U.S. Pat. No. 7,375,743, shows another surveillance system controller. It can control its camera, video storage, and other monitor. U.S. Pat. No. 7,335,026, shows another video surveillance system and method. U.S. Pat. No. 8,395,664 identifies a sophisticated wireless surveillance system and method for 3D visualization and user controlled analytics of captured data.

U.S. Pat. No. 8,305,447, shows a Security Threat Detection System.

U.S. Pat. No. 8,390,686 shows another surveillance camera apparatus and surveillance camera system where the camera is capable of being moved, to provide for its focusing. U.S. Pat. No. 7,379,119, shows a surveillance camera mount. U.S. Pat. No. 6,456,321, discloses a surveillance camera apparatus, remote surveillance apparatus and remote surveillance system having a surveillance camera apparatus and a remote surveillance apparatus.

The foregoing prior art generally discloses how various elements for surveillance and protection purposes have long been available in the art. These include the use of stun guns, laser sights, and cameras, even remotely operated surveillance devices, as previously reviewed and explained. The current invention, though, provides a combination of a variety of these components, which may be mounted in an area for providing discreet and non-obtrusive surveillance, incorporate the technology of a stun gun therein, as a camera to review the space, a laser for precisely sighting of the stun components, such that an operator in security, or the home office, can readily initiate the activities of this comprehensive device, for temporally apprehending a suspect under surveillance, and to prevent harm to the surrounding individuals or premises.

### SUMMARY OF THE INVENTION

This invention contemplates a new design for a security camera that incorporates a stun gun. The device may also include sighting means, such as a laser, which when the camera detects a target, the laser can be used to provide a precise setting, so that when the stun gun is initiated, it will embed or contact with the targets clothing, or body, to attain incapacitation. The purpose of this camera with its stun gun is to generally stop, or at least discourage, intruders from coming into schools, or other buildings or location, and harming children, or other personnel, in the process. Generally, it can be used as a first line of defense, in a nonlethal way, to discourage severe harm being perpetrated upon individuals and property. This day in age, examples are not needed of what type of horrors are being perpetrated upon our citizens, by those bent on maiming or killing of masses of humans, that the perpetrators many times do not even know.

The invention generally includes a housing, one which incorporates a camera, and the housing may be connected by a mounting means, as for example, in the upper corner of a schoolroom, hall, or other location. The mounting means may incorporate servo or other motors, which can provide for an elevational adjustment to the housing, and therefore its camera, and for lateral movement of the housing, to thereby furnish a full 90° quadrant of focusing of the camera, particularly when it is mounted, as aforesaid, in the upper corner of a room, such as a schoolroom.

The invention further contemplates the locating of the stun gun assembly within the housing, such stun guns normally project a pair of darts tethered by wires to a high voltage source, generally pulsed, so that when the darts arrive at the target, they can disable the targets muscles, and incapacitate him/her, that allows the authorities to immediately and safely move in to apprehend the individual.

The device further incorporates a laser sight, it can provide for pinpoint focus onto the intended target, which is being viewed by the camera, so that when the stun gun is initiated, and propels its darts, security can be fairly certain that the darts will arrive at the focal point upon the victim, once initiated.

Thus, the concept of this invention is to provide, in combination:

1. A housing;
a. Incorporating a camera;
b. Incorporating the structures of a stun gun, incorporating a pair or charged darts;
   i. Propelled by compression springs;
   ii. Propelled by a gas cylinder;
   iii. Propelled by an explosive cartridge;
c. A laser sight for focusing of the stun gun;

2. A mounting means for the housing;
a. Incorporating servo motors for vertical and horizontal adjustments to the housing;

3. Said housing providing remote surveillance means;
a. For hardwiring to the housing to provide it with control and operations;
b. For wireless control of the housing from a remote location;
c. For initiating the firing of the stun gun components to project the charged darts towards the target.

The foregoing provides a schematic of the various components that are assembled into the automated and remotely operated stun gun with integrated camera and laser sight of this invention. As expressed, generally the control means for the operations of this device will be either located in the head office of the school, or its security office, because generally if a terrorist act or a crazed individual enters into a schoolroom, intending harm upon everyone therein, the teacher will not have time to operate all of these mechanisms, in order to disable the target. But, providing the teacher with a simple switch, whether it be a remote operated switch, or one hardwired or wireless connected to a desk, can immediately inform security, et al, that a dangerous situation exists, and help is needed immediately. That can immediately be delivered by the defined invention herein, to provide a disabling of the one intending serious harm.

It is, therefore, the principal object of this invention to provide a fully integrated surveillance device that incorporates stun gun characteristics, and which can charge and project its darts towards an intended target.

Another object of this invention is to provide a housing incorporating not only stun gun components, but having a camera to provide for focusing upon the one intending harm.

A further object of this invention is to provide a housing incorporating not only stun gun components, and a camera, but further furnishing a laser sight that can be focused directly upon a particular part of the victim's body, to immediately fire the charged darts towards the victim.

Still another object of this invention is to provide a housing, that may be wall or ceiling mounted, and which can be adjusted both vertically and horizontally, for focusing directly upon the person intending harm.

Still another object of this invention is to provide a stun gun mechanism, within a housing, and which can be remotely operated by security, or others, through either hardwired or wireless applications allowing security to immediately focus the camera on the intended target, apply a laser sight for accurate focusing, and then initiate the stun gun components to project the charged darts towards the sighted victim.

Another object of this invention is to provide a stun gun, with housing, and other components, that are fully integrated into a singular unit to facilitate its mounting at a strategic surveillance location.

Yet another object of this invention is to provide a housing incorporating stun gun, camera, laser sighting, and other components that are fully integrated with electrical and electronic circuitry to provide for their full integration and operations for disabling one intending to do harm.

Still another object of this invention is to provide a stun gun device that may be used to add security, and to function as a deterrent, from anyone entering a school room, building, industrial complex, or office, with the intent to do harm.

These and other objects may become more apparent to those skilled in the art upon reviewing this summary of the invention, and upon undertaking a study of the description of its preferred embodiment, in view of the drawings.

### BRIEF DESCRIPTION OF THE DRAWINGS

In referring to the drawings:

FIG. 1 is an isometric view of the housing with stun gun, camera and laser applications, mounted to a wall, and capable of automated shifting and focusing in preparation for usage and application;

FIG. 2 is a front view of the housing, with its camera, laser sight, and the location of the stun gun dart chambers;

FIG. 3 is a back view of the housing, showing its hardwiring that allows for its remote actuation, sighting, and firing of its stun gun components;

FIG. 4 shows the frontal part of the housing as removed, and disclosing one of the darts, and its charged wiring connecting therewith, within the dart chamber;

FIG. 5 shows the front of the housing and its dart chamber, disclosing a dart that is propelled by means of its associated powder charge;

FIG. 6 shows the front part of the housing, with its dart chamber, and how the dart may be propelled by means of a compression spring;

FIG. 7 shows the front part of the housing, and its dart holding chamber, and how the dart may be propelled by a gas, CO2, or other compressed gas cartridge;

FIG. 8 shows a dart with its charged wire, that may be propelled by one of the previously described propellants, and disclosing its circuitry for providing a high voltage low amperage charge to the dart, through its wire, in preparation for its being propelled;

FIG. 9 shows the circuitry for converting AC power to direct current, a transformer for increasing voltage, a pulse circuit for pulsing the charge, as it is delivered to its wire for charging of its propelled dart;

FIG. 10 shows the circuit board within the housing, and for use for application of its various cables to provide functioning to its camera, laser sight, and for operations of the stun gun darts, preferably initiated by security at a remote location;

FIG. 11 shows the circuitry, and the various components, upon their circuit board, that can be used to control the camera, the sight mechanism, and provide stun gun firing, during application of this device;

FIG. 12 discloses circuitry for the battery operation of the device, contained within its housing, but can be wireless controlled from a remote location, for firing of a charged dart either by means of a primer, spring, or gas cartridge;

FIG. 13 provides a block diagram also showing the microchip for the control board for this invention;

FIG. 14 provides a circuit diagram of the various controls for operating the servo mechanisms of the invention; and

FIG. 15 shows an exploded view of the servo motor mechanisms used to provide horizontal and vertical shifting of the housing during usage of the device.

### DESCRIPTION OF THE PREFERRED EMBODIMENT

In referring to the drawings, and in particular FIG. 1, therein is shown the stun gun device 1 of this invention. As noted, it is mounted upwardly upon a wall structure W, but it could just as easily be mounted upon the adjacent wall, or upon the ceiling, through its mounting means 2. The stun gun device includes a housing 3, which furnishes an encasement for the various operative components that are associated with this device, and has a frontal face structure 4 that shows the lens portion 5 for the camera of this device. In addition, the front face discloses the location of the laser tip 6, in addition to mounting the two stun gun dart chambers 7 and 8, as can be noted. These will all be subsequently described.

The mounting means 2 includes at least one arm, as at 9, and it connects with a swivel joint 10 which provides a series of hemispherical portions 11-14, and which allow for its internally arranged servo motors to provide for pivoting of the various arms 9, and the arm 15 that secures the housing 3 of the device to its mounting means 2. Thus, when the servo motors (not shown) are operated, they can provide for a vertical pivot of the housing 3, or a lateral pivot of the housing 3, that allows the camera to be focused directly upon the identified target, as sought by the security operator. Other mounting devices such as to pivot vertical and horizontal separately through other pivotal device means can be envisioned and used.

FIG. 2 provides a frontal view of the front structure 4 of the device, showing the location of the camera lens 5, the laser sight 6 and the dart chambers 7 and 8, as can be noted.

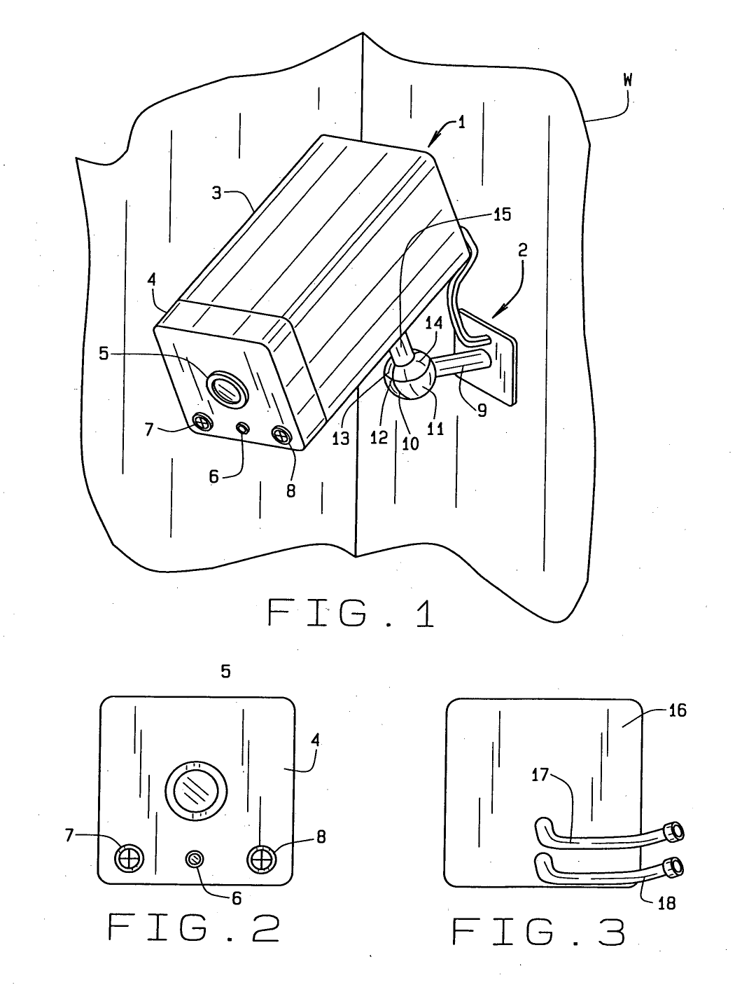

FIG. 3 shows a back view 16 of the housing, and discloses the means for providing hardwiring, as through the cables 17 and 18, in order to conduct charge for operating the various operative components, and the circuit board, for the device, that are contained within the housing 3.

FIG. 2 also discloses just where the darts can be loaded into the front of the stun gun, and more specifically into its chambers 7 and 8, for preparing the device for usage. Furthermore, obviously, the mounting means could be secured to either the bottom of the housing, as shown, or it can also mount to the sides, or the top of the camera housing, such as through pivotal brackets, in preparation for the installation and application of this stun gun device.

In addition, obviously, one of the cables 17, of FIG. 3, may be used to operate the camera, while the other cable 18 may be used to provide power hookup, for operating other components, such as the laser, or the operating mechanism, for triggering the projection of the charged darts, during usage of the device.

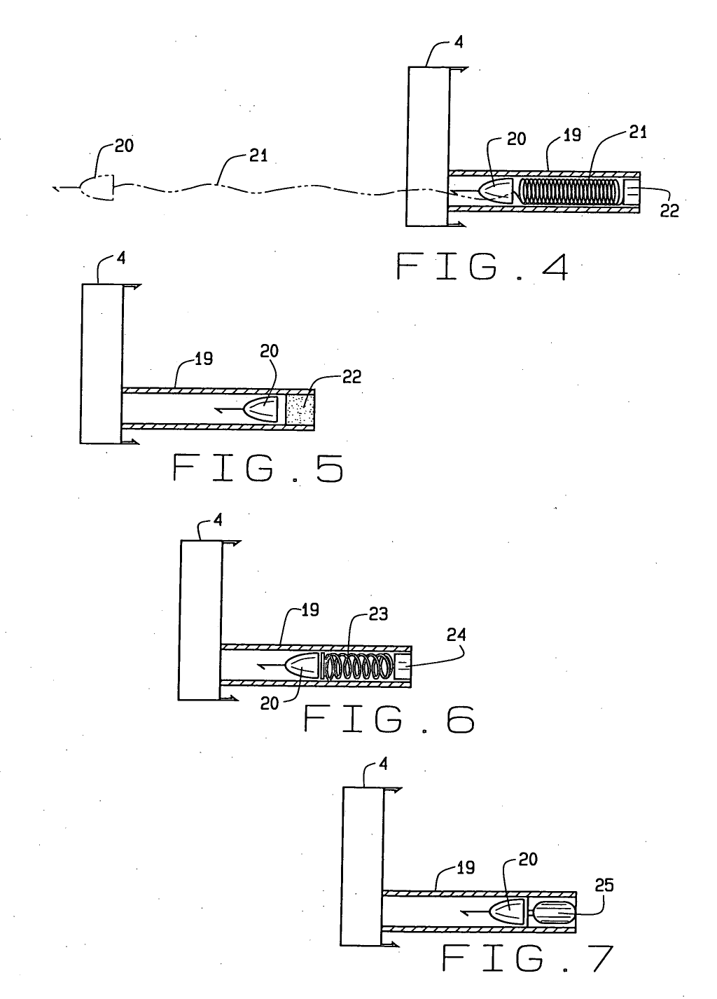

FIG. 4 discloses, once again, the front structure 4 of the device, in addition to its mounting of the dart chambers, the left side chamber 19 as shown herein. The chamber is shown mounting of its dart 20 therein, with its charged wire 21 connecting therewith, and a propellant 22 that may be ignited, for propelling the dart forwardly, and pulling its wire 21 with it, as can be seen in phantom line, where the dart is being projected forwardly, during usage and application of this device.

FIG. 5 is similar to the disclosure in FIG. 4, showing the front of the housing 4, the dart chamber 19, the location of its loaded dart 20, and its solid propellant 22 readied for ignition, and thrusting of the dart 20 forwardly, with its charged wire 21, as previously explained in FIG. 4.

FIG. 6 shows, once again, the front structure 4 of the housing, with its dart chamber 19 rigidly mounted within the housing 3, to its front structure 4. Obviously, there will be two dart chambers, one operatively associated with the front apertures 7 and 8 as previously explained with respect to FIG. 2, showing where the darts are thrusted forwardly, during their ignition, energization, or usage of the device as a stun gun mechanism. In addition, in this instance, the dart 20 is loaded against a compression spring 23, so that when its triggering mechanism 24 is initiated, it allows the compression spring to thrust forwardly, from its loaded condition, and project the dart 20 forwardly, in the manner as previously explained regarding the operations of the device as noted and explained in FIG. 4.

FIG. 7 shows the front structure 4 for the housing, with one of its dart chambers 19 provided therein. The dart 20 in this particular instance, is chambered against a CO2 or other gaseous vessel 25 such that when the device is triggered, the compressed gas will thrust the dart 20 forwardly, and pull with it the charged wire, as noted in FIG. 4 at 21, to project the dart forwardly, with its charged wire, as previously explained in said FIG. 4. These are examples of the various types of propellants that can be utilized in thrusting the pair of darts forwardly, during the application of this device.

When shot, the darts are thrusted forwardly from the stun gun, as a result of the ignition of the primer charges, spring, or gas cartridge, and pulls with the dart the coiled charged wire 21, as previously explained.

Obviously, each of these modifications in the means for projecting the darts forwardly will be operatively associated with a form of triggering mechanism, which in the case of the powder charge 22, may be an ignition means, in the case of the compression spring member 23, there will be a triggering mechanism that holds the spring in compression, when set, but when triggered, releases the spring to thrust forwardly at great pressure to force the darts out of the housing, and towards its intended target. Furthermore, in the case of the gas cartridge, as at 25, as explained in FIG. 7, the trigger mechanism may be a valve that can be triggered opened, to allow for quick release of its compressed gas, which thrusts the darts forwardly, towards their intended target. These types of trigger mechanisms could be mechanical, electromechanical means, that can be initiated remotely by a security operator, that provides for an instantaneous triggering of the device, initiation of its propellant means, whether it be any one of those as described, and thrusts the darts forwardly at significant speed, for impacting upon the target, and to perform their stunning procedure thereon.

FIG. 8 shows some of the circuit diagram as used in conjunction with the operations of the device. Many of these components may be assembled onto a circuit board, and provide the various electrical operations required for performance of a stun procedure. For example, a dart chamber, as at 19, and which may be the type of chamber that mounts to the front face structure of the housing, or within the housing itself, holds the coiled charged wire 21, as previously explained. Such wire connects with the dart 20 as also previously explained.

The chamber 26 may provide the space for holding a primer charge, a spring loading, or a CO2 cartridge, as can be understood. These will thrust the dart 20 forwardly, during each of their individual operations.

There may be a further chamber 27 built into the structure rearwardly, as noted, and this particular chamber may hold a battery, or other charging means, that can also supply the electrical charge necessary for the operations of the device, the charging of its wire 21, and the transmission of the high voltage low amperage charge to the front of the dart, as at 20A. This device can also work in conjunction with the various circuitries, as noted, to provide for triggering of the mechanism, upon firing of the stun gun darts.

The various electronic components, such as the capacitor 28, the diode 29, transistor 50, the DIAC 30 and the surge arrester 31, in addition to the resistors 32 and 33, function in conjunction with the various capacitors 34 and 35 to cooperate with the transformer windings 36 for furnishing the high voltage, low amperage, to charge the wire 21, and its associated dart, during usage.

The circuitry as previously described generally furnishes the charging necessary to the stun gun components, to furnish their desired high voltage, within their required parameters, at low amperage, for charging of the darts, during usage.

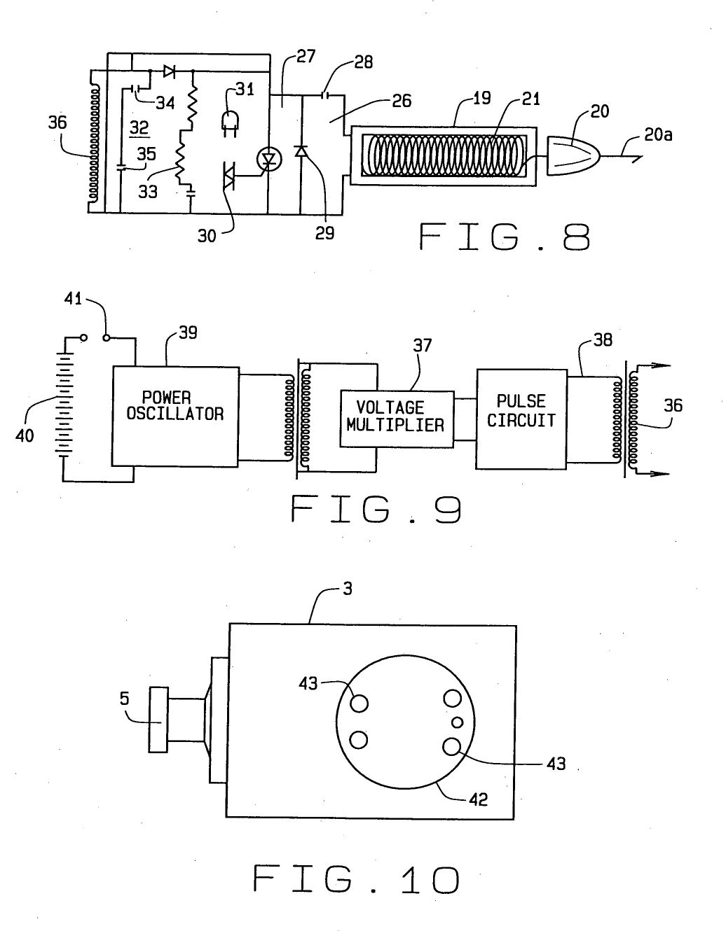

The circuitry shown in FIG. 9 discloses the power regulating means that typically steps up the voltage, as to its transformer 36, to between about 400-1,200 volts, at a low amperage setting. This circuitry also rectifies the AC current to a direct current, which is voltage multiplier, as at 37, and then pulsed, as at 38, that furnishes the safe high voltage required to stun a person, but not to do any severe harm. The power oscillator 39 receives its power from the input battery, as at 40, and the switch 41 is generally remotely operated, either through a hardwire connection, or by means of a wireless transmission, to initiate the circuitry, the charging of the darts, and the initiation of the triggering means, that either ignites the power charge, releases the spring as a propellant, or opens the compressed gas capsule, to thrust the dart forwardly, upon initiation of a triggering cycle.

As previously explained, the security camera portion of this device, and the stun gun system itself, is generally controlled from a control room. It can either be controlled through the hardwiring, or by a wireless remote control means, that can turn on and initiate the trigger of the device, after focusing has been obtained through usage of its camera, and laser sight. The control room could either be, as previously explained, at a security location, or in a school, within the principal's office, as can be determined. The device will incorporate a security code, so it can only be activated by authorized personnel. Where hardwiring is used, such wires can be located within the mounting bracket or means, and then extended into the wall, or the wires can be run though a conduit, or other wire casing, so that unauthorized access can not be obtained to the device, its charging circuitry, that can lead towards tampering, and initiation by unauthorized persons.

The control of this device in the control room may be done by any type of control panels, even a joystick that may manipulate the camera to attain focusing on the target through its laser sight, as can be understood.

FIG. 10 discloses a schematic view of the housing 3, with its camera lens 5 shown on the front, and having its control panel 42 showing the various connecting points where the various hardwires may be connected, for providing the electrical operations of the camera, the laser sight, the stun gun, and the means for attaining an initiation and operation of each of these components. The various wire connecting points can be seen at 43.

FIG. 11 shows another schematic view of the circuit board for this invention, which will locate within the housing, and which provides for the control of the electric charge for operation of its various components, as can be explained. For example, the circuit board 44 may include an antenna 45 that may furnish the means for providing remote or wireless functioning of the components of this device. A computer chip 46 furnishes the central control for the various operations of the device. The connecting board 47 provides the contact points where the various electrical wires within the system may secure, when the device is hardwired for operation. This device may also incorporate a memory chip, which provides for the controls in conjunction with the computer 46, for the proper operations of the stun gun device.

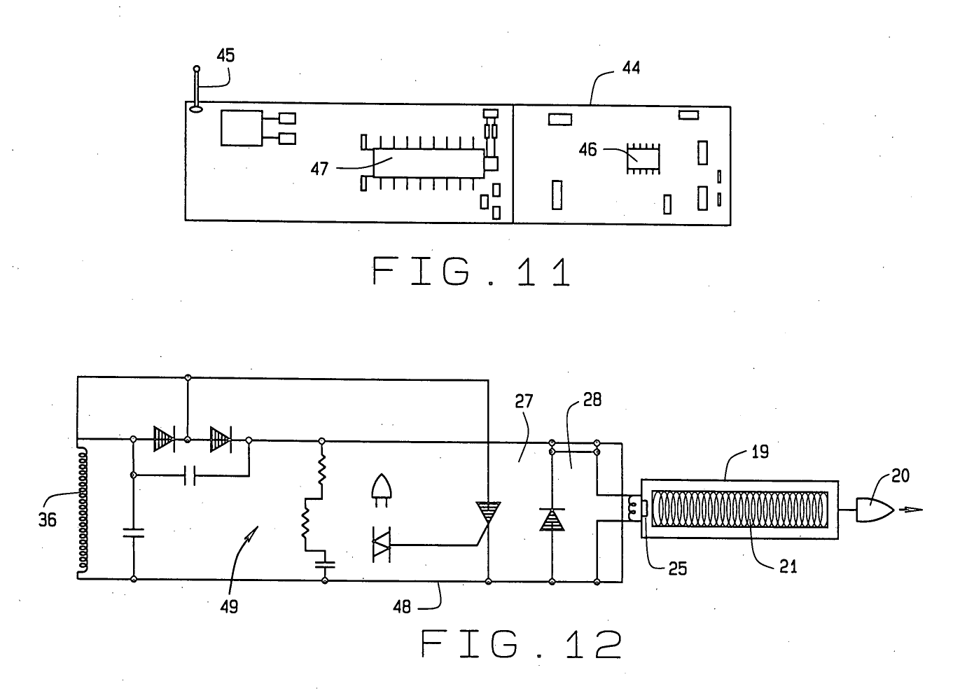

FIG. 12 shows a further schematic of the dart chamber 19, one of its darts 20, and the charged wire 21 that locates within the chamber. The means for propelling the dart, in this instance a CO2 cartridge, is located at 25. The device is shown connecting with its specific circuitry, as at 48. This circuit board is similar to the circuitry as explained in FIG. 8, and has the same operations as defined therein. The device includes its backup battery means 27, its chamber for the propellant, as at 28, and the circuitry for use for triggering all of these components, after the transformer 36 has stepped up the voltage for charging of the dart 20, in preparation for usage. The other electrical components, as generally noted at 49, are for the same uses as previously explained, for operations of the stun gun components of this device. Obviously, the entire unit can be easily programmed, with optional software, so as to initiate the function of operations of the device, even from a remote location, that may initially charge up the darts through its charged wire 21, with a high voltage, and the same time the program will initiate the operations of the camera, that may video back to security room pictures of the location where danger is emanating, and at the same time initiate the operations of the laser, for sighting purposes. Once that is all done, and the target is sighted, the operator can trigger the device, through the various electronic and electrical means as previously described, for thrusting the pair of darts forwardly, and embedding them upon either the clothing, or onto the surface of the target, to stun the individual into submission. Obviously, all of these controls, from the various circuit boards, will control the camera functions, the searching and sighting functions through the use of the laser, operate the servo motors for focusing the camera for affixing upon the target, provide for immediate preparation of the stun gun for operations, and then incorporate a remote trigger that allows for the stun gun components of this device to activate, and thrusting their charged darts forwardly, to complete their desired function.

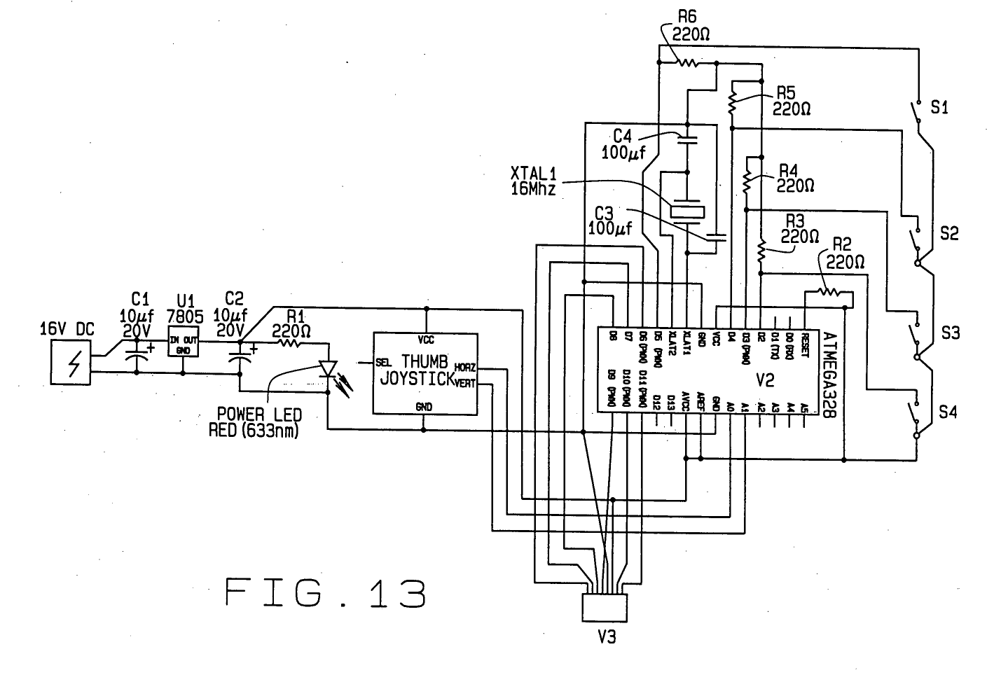

FIG. 13, as stated, shows a block diagram and the computer means with circuitry for the control board for this invention. As can be seen, and as previously reviewed, a 7v-16 v DC charge is required to power the voltage regulator U1 (L7805 Linear Voltage Regulator) of this invention. The higher end of the energy spectrum will require that voltage regulator to have a heat sink, for obvious reasons. The capacitor C1 (10 uf) is provided to stabilize and balance out the input power in case of a power surge, and the capacitor C2 (10 uf) is located to maintain the 5 v supply from the voltage regulator at a steady 5.00 volts, 0.1 volts. The 5 v source feeds directly to the two axis potentiometer (thumb joystick), and the power LED w/resistor R1 (220 ohms), the microcontroller (ATMEGA328), and also is used in the pull down momentary buttons (S1, S2, S3, and S4). These are what provide control for the device, through physical manipulation of its joystick, as noted.

The microcontroller (ATMEGA328) requires the use of an oscillating crystal (XTAL1, XTAL2 16 MHz) to determine its clock speed to run its program that is implemented through the microchip. Capacitors C3 and C4 (100 nf) are provided to ensure the oscillating crystal is running within specifications of 16.000 MHz.

The buttons are wired pull-down through using the resistors (R2, R3, R4, R5 220 ohms). Switch (S1) is preprogrammed to operate the laser on the receiver unit and is programmed with a delay (500 ms) and debounce to prevent accidental power and arming of the unit. All buttons are wired to the digital input pins on the atmega328 (D2, D3, D4, D5). The microcontroller will output the switches to digital pins (D6, D7, D8, D9) after following the preprogrammed instructions.

The thumb joystick consists of four wires (VCC, GND, X-Axis, and Y-Axis). Ground is connected to earth, the VCC is connected after the linear voltage regulator, and the x and y axis is connected to the analog inputs on the microcontroller (A0, A1). The microprocessor will read off this and follow the program and convert these signals to PWM (pulse-width modulation) through the controller, to operate the servos on the receiving end. Speed and limits can be adjusted through programming.

The RJ-45 (8 conductor) is used as an output to the receiver unit(s) utilizing CAT 5/6 cable. The VCC and the GND are connected across this to bridge and voltage spikes and differences. The four digital outputs and the two PWM outputs are directly wired to this jack.

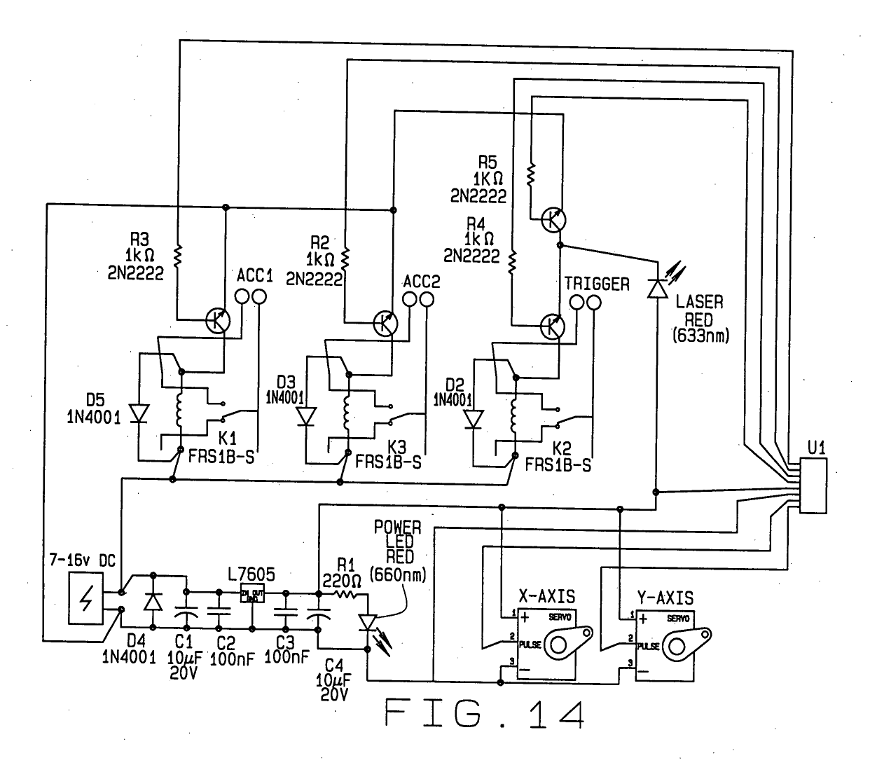

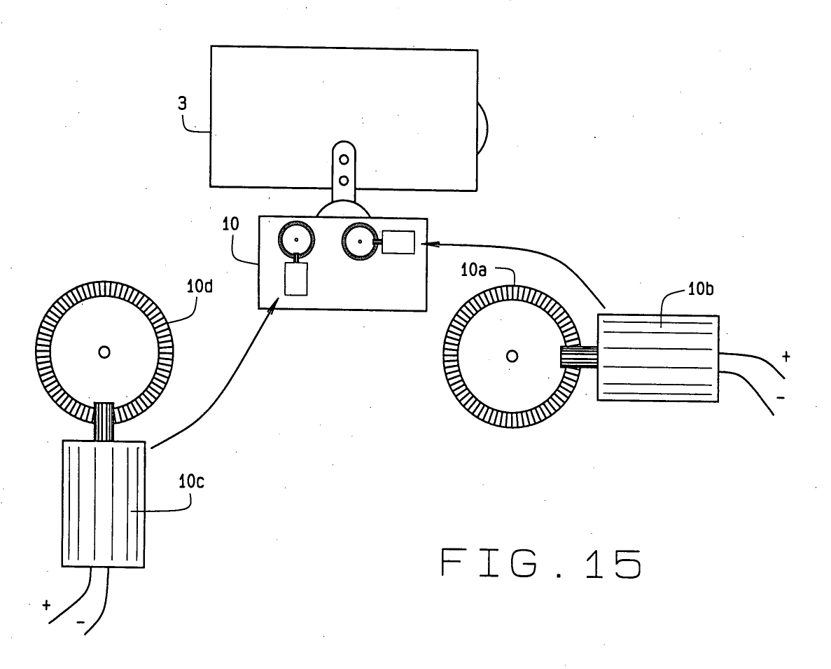

FIG. 14 shows the circuit diagram for the automated and remotely operated stun gun with integrated camera and laser sight of this invention. Essentially, a 7 v-16 v DC, as previously noted, is required to power the voltage regulator U1 (L7805 Linear Voltage Regulator) of this invention. The higher end of the spectrum will require that voltage regulator to also have a heat sink associated with it. Capacitors C1 (10 uf) and C2 (100 nf) are provided to stabilize and balance out the input power in the event of a power surge. Capacitor C3 (100 nf) and C4 (10 uf) are located to maintain the 5 v supply from the voltage regulator at a steady 5.00 volts+−0.1 volts. The 5 v output for the voltage regulator will be powering the servos for their pan and tilt control (horizontal and vertical movements) and for switching the laser on and off, shown as (Laser). The 5 v output also operates the relays (K1, K2, K3, K4), as noted. A 1N4001 rectifier diode is included in the circuitry to prevent reverse polarity, during operations of the device.

The servos (X-Axis, Y-Axis) are controlled with the incoming PWM signal from the RJ-45 jack.

The relays include 1N4001 diodes (D2, D3, D5) that are installed to protect all the electronics from feedback when the relay is disengaged. The relays are controlled by the 2N2222 NPN transistors, as noted. The transistors purposes are to ensure that any power surges will not engage any of the relays. The relay K2 purpose is to control the high voltage firing mechanism. This relay is protected by the two said transistors. The purpose of the dual transistors is to put in place controls during operations of the device. The firing relay will not operate by any circumstance unless the laser is on, and powered, for operation.

Relays K1 and K3 are provided for additional options and accessories, as may be desired or required.

This provides a description of the circuitry for operations of the invention, through its thumb joystick, for operations of the servo motors, and for sighting and firing of the device during emergency usage.

FIG. 15 shows a schematic, in an exploded view, of the servo mechanisms used to provide for the vertical and horizontal shifting of the housing 3 of the device, during usage. As can be seen, the swivel joint 10 includes the means for pivoting of the housing in both a vertical direction, and horizontal direction, when sighting the remotely operated stun gun. For example, within the housing 10, there is a gearing 10A that is rotated through the motor 10B, and through this it provides for horizontal shifting of the housing 3, during its sighting. The gear motor 10C provides for turning of its connected gear 10D, to provide for vertical shifting of the housing during its sighting. These are all done through the operations of these various servo motor mechanisms, which are connected by circuitry to the control at a remote location, to furnish guidance, through its camera means, and its laser sighting, to focus the stun gun for initiation when projecting its various darts accurately towards the focused target.

Variations or modifications to the subject matter of this invention may occur to those skilled in the art upon review of the disclosure as provided herein. Such variations, if within the spirit of this invention, are intended to be encompassed within the scope of any claims to patent protection issuing hereon. The description of the preferred embodiment, the summary of the invention, and the depiction of the invention in the drawings, are primarily set forth for illustrative purposes only.

We claim:

1. An automated and remotely operated stun gun with integrated camera and laser sight, including a housing, said housing mounting a camera for sighting of a suspect target, a laser sight, operatively associated with the camera, for providing sighting upon the suspect target, a mounting means connecting with the housing, said mounting means incorporating at least one servo motor for providing mechanical shifting of the housing in both vertical and horizontal directions, in order to be adjusted and focus specifically upon a suspect target, a pair of stun gun dart chambers mounting upon the housing, and capable of projecting a pair of darts forwardly at the suspect target, each dart chamber holding a supply of chargeable wires, each operatively associated with one of said darts, in order to charge the darts with a high voltage when projected towards a suspect target, circuitry operatively associated with the housing, said circuitry providing for the processing of charge to a high voltage for charging of the charged wires and darts, said circuitry also providing for control and functioning of the camera, laser sight, and servo motors of the mounting means during their actuation, said device capable of being operated by one of hardwiring and wireless from a remote location to function as a deterrent and disabling means to prevent a suspect target from causing damage to the surrounding people and vicinity.

2. The integrated camera and laser sight of claim 1 wherein said laser sight is also included within said housing.

3. The integrated camera and laser sight of claim 1 wherein said camera is also located within said housing.

4. The integrated camera and laser sight of claim 1 wherein there are two servo motors provided within the mounting means, the first servo motor provided for inducing movement of the housing in a horizontal direction, and the second servo motor provided for furnishing vertical movement of the housing during sighting of a suspect target.

5. The integrated camera and laser sight of claim 1 and including a microcontroller operatively associated with the circuitry and provided for regulating the operations of the camera and laser sight in the horizontal and vertical directions during sighting of a suspect target.

6. The integrated camera and laser sight of claim 5 and including a joystick operatively associated with the circuitry incorporating the microcontroller, and to provide for manual manipulation of the housing and its contained camera and laser sight in the X and Y axis upon sighting of a suspect target.

7. The integrated camera and laser sight of claim 5 wherein said circuitry includes a series of relays, said relays provided for controlling the initiation of operations of the laser, camera, and firing mechanism for the stun gun, during operations of the device.

8. The integrated camera and laser sight of claim 7, and including the series of diodes, which when operative protecting the electronics of the relays from feedback when said relays are disengaged.

9. The integrated camera and laser sight of claim 8, and including a series of capacitors, operatively associated within the circuitry of the device, and parallel arranged with the relays, to provide for stability and balance out the input power of the circuitry and to protect it from any power surge.

10. The integrated camera and laser sight of claim 9, and including a diode operatively associated with each of the relays, and provided to protect the relays from feedback when the relay is disengaged.

11. The integrated camera and laser sight of claim 5, and including a microprocessor operatively associated with the microcontroller, and a series of capacitors operatively associated with the microprocessor, with said capacitors provided to stabilize and balance the input power to the microprocessor in the event of a power surge, to assure a 5 volt supply from the voltage regulator during operations of said device, and to ensure the device is functioning within its microhertz specification.

12. The integrated camera and laser sight of claim 1 wherein the means for projecting the charged darts towards a suspect target includes one of compressed gas from a cylinder, an explosive cartridge, and compression springs, to achieve dart propulsion.
